(19) United States
(12) Patent Application Publication
(10) Pub. No.: US 2014/0104678 A1
(43) Pub. Date: Apr. 17, 2014

(54) Tunable Quantum Dot Laser With Periodically Poled Nonlinear Crystal

(71) Applicants: Edik Rafailov, Nethergate (GB); Ksenia Fedorova, Nethergate (GB); Grigorii Sokolovskii, Nethergate (GB)

(72) Inventors: Edik Rafailov, Nethergate (GB); Ksenia Fedorova, Nethergate (GB); Grigorii Sokolovskii, Nethergate (GB)

(73) Assignee: UNIVERSITY OF DUNDEE, Nethergate, Dundee (GB)

(21) Appl. No.: 14/110,506

(22) PCT Filed: Apr. 10, 2012
(86) PCT No.: PCT/GB2012/000319

§ 371 Date: Dec. 23, 2013

(30) Foreign Application Priority Data
Apr. 8, 2011 (GB) 1105982.1

(51) Int. Cl. H01S 3/00

(52) U.S. Cl. CPC H01S 3/0092
USPC 359/328

(57) ABSTRACT

The present invention uses nonlinear crystal waveguides to provide a continuous wave and picoseconds pulse laser systems that gives an order-of-magnitude increase in IR-to-visible conversion efficiency and also provide an order-of-magnitude increase of wavelength range for SHG conversion. The idea of enabling such broad tunability is based on the utilization of a significant difference in the effective refractive indices of the high order and low order modes in the waveguide. This feature enables the difference between the effective refractive indices of the fundamental and second-harmonic waves to be shifted to match the period of poling in a very broad wavelength range.

### INTRODUCTION

The present invention relates to laser systems and in particular to tunable laser systems in the continuous wave and picoseconds regimes.

### BACKGROUND

Laser sources emitting in the visible spectral range of 550 to 650 nm have many applications in biomedical technology spectroscopy photodynamic therapy ophthalmology for cytometry and laser projection display technology. Commercially available lasers in this spectral range are in practice mainly bulky and difficult to use.

Quasi-phase-matching is an important and widely-used technique in nonlinear optics enabling efficient frequency up-conversion. However, since its introduction almost half a century ago, this technique has been intrinsically limited in spectral tunability by the strict conditions set by spatial modulation which compensates the momentum mismatch imposed by the dispersion

Frequency doubling of infra-red (IR) light based on the generation of new laser wavelengths via a material's nonlinearity X⁽²⁾ in nonlinear' crystals is one of the most attractive ways for the realization of compact laser sources in the visible spectral region.

To enable efficient conversion, or second harmonic generated light (SHG), both photon energy conservation E_{λ}=2E_{2λ} and momentum conservation k_{λ}=2k_{2λ} should be achieved simultaneously. However, the requirement of photon momentum conservation (also called the “phase-matching” constraint) is difficult to achieve due to dispersion of the refractive index in the nonlinear crystal (i.e. due to the obvious fact that the refractive index for IR light is different from that for light in the visible spectral range resulting in difference of phase velocities for IR and visible light waves propagating through the crystal).

Without phase matching, the generated second harmonic grows and decays as the fundamental (IR) and second harmonic (visible) waves go in and out of phase over each coherence length l^{c}¹:

$${l}_{c} = \frac{λ}{2 \vert {n}_{λ} - {n}_{2 λ} \vert} , \qquad ( 1 )$$

where λ is the second harmonic wavelength, n_{λ} and n_{2λ} are the refractive indices for the visible and IR light. In other words, out-of-phase SHG leads to the total suppression of the second harmonic light by radiation generated in the distance of coherence length l_{c} due to the opposite phases of these waves. Therefore, phase matching between interacting waves is mandatory in order to achieve efficient frequency conversion. A known, commonly used approach for this is the periodical poling (or ‘quasi-phase-matching’—QPM) of ferroelectric nonlinear crystals by periodically reversing the crystals polarization under the influence of a sufficiently large electric field. When the poling period corresponds to double the coherence length Λ=2l_{c}, then the proper phase relationship between the propagating waves is maintained and the SHG efficiency is maximised with the quasi-wave-vector of the periodically poling grating enabling momentum conservation k_{λ}=2k_{2λ}+k_{λ}:

$$\frac{2 π {n}_{λ}}{λ} = 2 \frac{2 π {n}_{2 λ}}{2 λ} + \frac{2 π}{Λ} , \qquad ( 2 )$$

Equation (2) means that almost no tunability can be introduced to the SHG system involving periodical poling of the nonlinear crystal.

Current state-of-the-art SHG tuning approaches include multiple-grating and temperature-assisted tuning with short-pulsed and CW pumping (including diode pumping) but both are limited to only few nm tuning range. Great progress in tunability was achieved with ‘random’ quasi-phase-matching in polycrystalline materials enabling the generation of second harmonic from green to red with the obvious drawback being an extremely low conversion efficiency even with short-pulsed pumping. The most promising approach to the broadly tunable SHG involve Fibonacci or Fourier-constructed quasi-periodical poling. This opens up the possibility of achieving general solutions to the multiple-phase-matching problem. Unfortunately, this technique suffers from complicated poling mask requirements and is obviously not free from the compromise of conversion efficiency. Another approach utilizes counter-propagating light pulses enabling the enhancement of high-harmonic emission by scrambling the quantum phase of the generated short-wavelength light, to suppress emission from the out-of-phase regions, this technique has only been applied to x-ray and extreme ultra-violet generation.

Spatiotemporal’ quasi-phase-matching has been demonstrated to enable momentum and energy conservation through a combination of spatial and temporal modulation of pumping light. This technique is not applicable for CW regime but is absolutely free of the compromise of conversion efficiency when extremely short-pulsed pumping is available.

### SUMMARY OF THE INVENTION

In accordance with a first aspect of the invention there is provided a frequency doubling tunable laser system in the continuous wave (CW) and picoseconds regimes, the system comprising a quantum-dot laser optically coupled with a periodically poled nonlinear crystal waveguide.

Preferably, the quantum-dot laser is a pump external-cavity diode laser (ECDL) with a QD gain chip.

Preferably, the nonlinear crystal waveguide is a single nonlinear crystal waveguide.

Preferably, the quantum dot laser comprises variable size quantum dots.

The idea of enabling such broad tunability is based on the utilization of a significant difference in the effective refractive indices of the high order and low order modes in the waveguide. This feature enables the difference between the effective refractive indices of the fundamental and second-harmonic waves to be shifted to match the period of poling in a very broad wavelength range

The present invention provides for the creation of extremely broadly tunable semiconductor lasers thanks to the utilization of size-variable Quantum Dots (QDs) Quasi phase matching (QPM) crystals have not been used for broadly tunable SHG. However, if similar tunability is provided then a single-chip QD laser emitting in a broad range exceeding 200 nm would provide full-colour SHG.

Preferably, the waveguide structure is adapted for the excitation of higher-order modes which enables the difference between the effective refractive indexes of the fundamental frequency waves and SHG frequency waves to be shifted to match periodic poling in a very broad wavelength range.

Preferably, the waveguide structure is configured to provide a low difference between refractive indexes of low-order fundamental and high-order SHG modes to enable blue shift of the effective poling period whilst a higher difference between high-order fundamental and low-order SHG refractive indices provides a red shift.

Preferably, tunability of the system can be extended by increasing the refractive index step of the waveguide Δn.

Preferably, tunability of the system can be extended by choosing material with an appropriate refractive index change due to dispersion.

Preferably, the waveguide is a periodically poled potassium titanyl sulphate waveguide (KTP).

Alternatively, the waveguide is a periodically poled lithium niobate waveguide.

Alternatively, the waveguide is a periodically poled potassium dihydrogen phosphate (KDP)

Preferably, the poling period is between poling period of 5-20 μm.

Optionally, for a lithium niobate waveguide Δn is up to 0.14.

Optionally for a KTP waveguide, Δn up to 0.04.

Preferably, the laser system provides tunability of the order of, or even exceeding, the whole visible spectrum.

Preferably, the laser system operates at room temperature in the visible spectral range.

Preferably, the laser system operates in the range 567.7 nm to 629.1 nm in CW regime

Preferably, the laser system operates in the range 600 nm to 627 nm in picoseconds regime

Preferably, the laser system operates by frequency doubling in the periodically poled KTP waveguide crystal using a tunable quantum-dot external-cavity diode laser.

Preferably, the laser system is compact.

Preferably, the laser system of the present invention provides a conversion efficiency up to 7.9% in the CW regime

Preferably, the laser system of the present invention provides a conversion efficiency up to 4.55% in the picosecond regime

Optionally, the laser system output can be optimised via reshaping of the output beam in a multimode fibre.

Optionally, the utilisation of slightly aperiodical (“chirped”) poling or tapered waveguide in the nonlinear crystal provides continuous wavelength tuning for realization of the full colour laser source.

Preferably, the laser system of the present invention provides very broad wavelength tunability of the second harmonic generated light (SHG) in the spectral region between 600 and 627 nm with conversion efficiency up to 4.55% in the picosecond regime

In accordance with a second aspect of the invention there is provided there is provided a green-to-red tunable continuous wave (CW) laser system based on frequency doubling of a quantum-dot laser in a PPKTP waveguide.

Preferably, the waveguide structure is adapted and excitation of higher-order modes enables the difference between the effective refractive indexes of the fundamental and SHG waves to be shifted to match periodic poling in a very broad wavelength range.

A low difference between refractive indexes of low-order fundamental and high-order SHG modes enables “blueshift” of the effective poling period whilst a higher difference between high-order fundamental and low-order SHG refractive indices makes it possible to “red shift” the second-harmonic generation.

Preferably, the laser system operates at room temperature in the visible spectral range.

Preferably, the laser system operates in the range 567.7 nm to 629.1 nm.

Preferably, the laser system operates by frequency doubling in the periodically poled KTP waveguide crystal using a tunable quantum-dot external-cavity diode laser.

Preferably, the laser system is compact.

Preferably, the laser system of the present invention provides very broad wavelength tunability of the second harmonic generated light (SHG) of over 60 nm in the spectral region between 567.7 and 629.1 nm with conversion efficiency up to 7.9%

### BRIEF DESCRIPTION OF THE DRAWINGS

The present invention will now be described by way of example only with reference to the accompanying drawings in which:

FIG. 1 is a simplified schematic diagram of the effective refractive indices for the fundamental and second harmonic modes of different order of the present invention;

FIG. 2 is a schematic diagram of an apparatus in accordance with the present invention;

FIG. 3a is a graph of poling period plotted against SHG wavelength, FIG. 3b is a graph of tunable range plotted against refractive index step for a range of non-linear single crystals;

FIG. 4 is a graph of frequency doubled output power versus launched pump power for several SHG peaks corresponding to phase-matching between fundamental and SHG modes of different orders;

FIG. 5 shows the dependence of SHG conversion efficiency and launched pump power on wavelength with the observed intensity profiles of second-harmonic and fundamental modes;

FIG. 6 a is a graph of poling period plotted against SHG wavelength and FIG. 6b (I to XIV) illustrate the observed intensity profiles of the second-harmonic and fundamental modes in the spectral region between 5671 and 629.1 nm;

FIG. 7 is a graph of frequency-doubled output peak power versus launched pump power for 600 nm, 613 nm and 627 in a second embodiment of the present invention; and

FIG. 8 is a graph which plots intensity versus SHG wavelength to describe the Optical spectra of the SHG at 600 nm, 613 nm and 627 nm.

### DETAILED DESCRIPTION OF THE DRAWINGS

The present invention uses nonlinear crystal waveguides to provide a laser system that gives an order-of-magnitude increase in IR-to-visible conversion efficiency and also enable a very different approach to SHG tunability in periodically-poled crystals by providing an order-of-magnitude increase of wavelength range for SHG conversion. The idea of enabling such broad tunability is based on the utilization of a significant difference in the effective refractive indices of the high order and low order modes in the waveguide. This feature enables the difference between the effective refractive indices of the fundamental and second-harmonic waves to be shifted to match the period of poling in a very broad wavelength range.

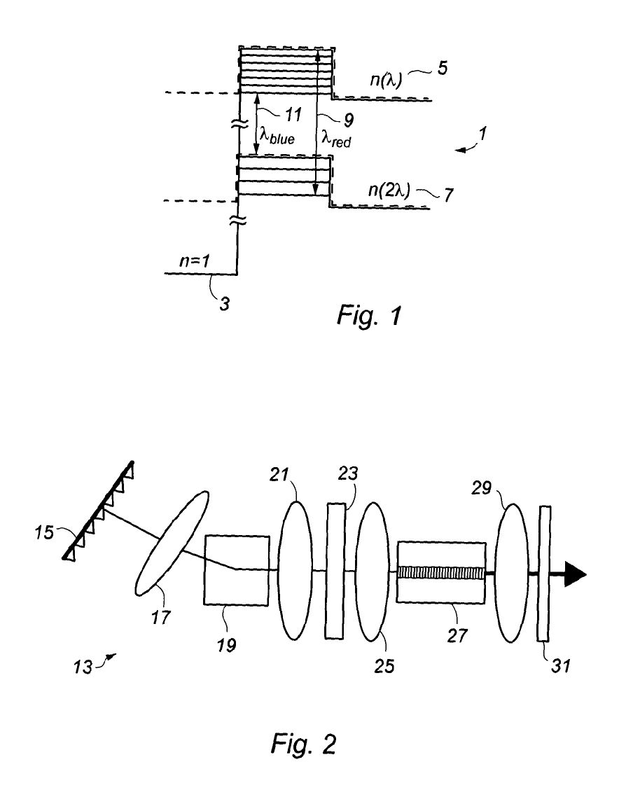

FIG. 1 shows a simplified schematic diagram of the effective refractive indices for the fundamental and second harmonic modes of different order. The free space refractive index 3 where n=1 is shown and the refractive indexes for the fundamental modes 7 is shown above the refractive indices of the second harmonic modes 5. The maximum difference 9 is shown by λ_{red} and the minimum difference 11 by λ_{blue}

From (1) and (2), for the multimode waveguide the total tunable range can be approximated as:

Δλ=λ_{red}−λ_{blue}≈Λ(2Δn+δn_{disp}), (3)

where Δλ is the difference between the most ‘red’ 9 (λ_{red}) and ‘blue’ 11 (λ_{blue}) visible wavelengths that can be generated in the nonlinear crystal with poling period Λ. Δn is the waveguide refractive index step (approximated to be the same for IR and visible range), and δn_{disp} is the refractive index change due to dispersion which is a combination of refractive indices corresponding to the most ‘red’ and ‘blue’ IR and visible wavelengths: δn_{disp}=n_{2λblue}−n_{2λred}−n_{λblue}+n_{λred}.

FIG. 2 is a schematic representation of an apparatus 13 in accordance with the present invention. The figure shows a number of optically coupled components including a diffraction grating 15, lens 17, a gain chip 19, a half wave plate 23 between lenses 21 and 25, a frequency doubling crystal 27, lens 29 and filter 31.

The PPKTP crystal used in this example of the present invention was periodically poled for SHG at 1183 nm and was fabricated by an ion-exchange technique to embed the waveguide. With this technique, the masked KTP was immersed in the ion-exchange bath consisting of a mixture of molten nitrate salts of Rb and Ba (RbNO3 and Ba(NO₃)₂). Within this bath, the Rb ions diffuse through a mask into the substrate, while the K ions diffuse out of the KTP crystal. In the diffused regions, the Rb ions increase the refractive index relative to the undiffused KTP and thus form the optical waveguide. The addition of a few percent of Ba(NO₃)₂ salt to the melt improved the uniformity of the waveguide. In this example of the present invention the PPKTP frequency doubling crystal was 16 mm long (not AR coated) and was periodically poled for SHG at 1183 nm with a poling period of 12.47 microns for the CW embodiment.

The waveguides have a cross sectional area of 4×4 μm² and a reflective index step (Δn) of approximately 0.01.

In this example, the pump external-cavity diode laser (ECDL) consisted of a QD gain chip operating under in a quasi-Littrow configuration. Coarse wavelength tuning of QD-ECDLs at 20° C. between 1130 nm and 1308 nm in CW and 1193 nm and 1284 nm in mode-locked regime was made possible by changing the incidence angle of the grating. The output of the front facet was collimated and then was coupled into the PPKTP waveguide using an AR-coated aspheric lens. Both the pump laser and the PPKTP crystal were operating at room temperature

The QD gain chips were fabricated from a QD wafer structure, with an active region containing 10 non-identical InAs QD layers, incorporated into Al_{0.35}Ga_{0.65}As cladding layers and grown on a GaAs substrate by molecular beam epitaxy. For the CW regime, the gain chip ridge waveguide had a width of 5 μm and length of 4 mm, and was angled of 5° with respect to the normal to the back facet, in order to significantly reduce its reflectivity. Additionally, both facets also had conventional anti-reflective (AR) coatings, resulting in total estimated reflectivities of 2·10⁻³ for the front facet and less than 10⁻⁵ for the angled facet.

The QD gain chip was mounted on a copper heatsink and its temperature was controlled by a thermo-electric cooler. The gain chip was set-up in quasi-Littrow configuration whereby the radiation emitted from the back facet was focused with an AR-coated aspheric lens (NA ˜0.55) onto a diffraction grating with 1200 grooves/mm, which reflected the first order diffraction beam back to the gain chip. The refractive indices for KTP, LN, KDP and LI crystals were calculated using the Sellmeier equations from Nikogosyan, D. N. Nonlinear Optical Crystals: A Complete Survey. (Springer, N.Y., 2005).

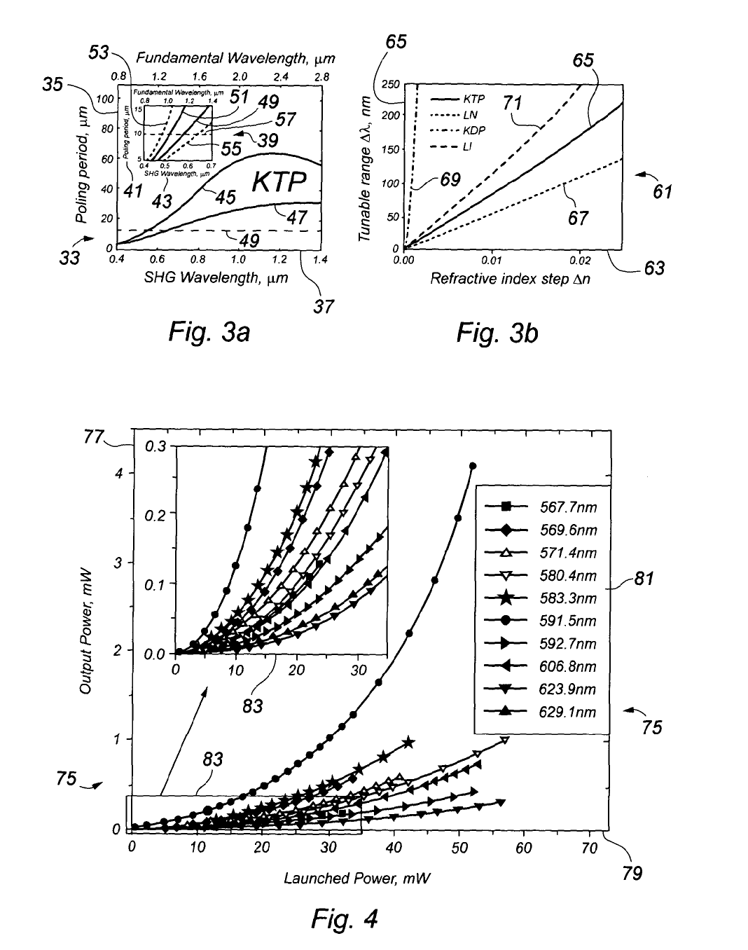

FIG. 3a, is a graph 33 which shows the calculated dependence of the poling period 35 with respect to SHG wavelength 37. The figure illustrates SHG tunability caused by significant difference of the effective refractive indices of the high- and low-order modes in a PPKTP waveguide with Δn=0.01.

According to equation (1), the small difference between refractive indices of low-order IR and high-order visible modes enables a “blue-shift” of the effective poling period curve 45 while a larger difference between refractive indices of high-order IR and low-order visible modes introduces a “red-shift” curve 47. The horizontal dashed line 49 represents the physical poling period of the crystal of ˜12.47 μm used herein.

The inset 39 shows the PPKTP waveguides with Δn=0.01 represented by solid lines 49, 51 for red and blue shifts respectively and 0.025 represented by dashed lines 55, 53 for red and blue shifts respectively. The horizontal dashed line 57 represents the physical poling period of ˜9.7 μm, which corresponds to the QPM in the spectral region between 480 and 640 nm for Δn=0.025

The range of tunability can be extended by increasing the refractive index step of the waveguide Δn or by choosing material with an appropriate refractive index change due to dispersion δn_{disp}. FIG. 3b is a graph 61 of tunable range 65 plotted against refractive index step 63 for some examples of nonlinear crystals calculated according to equation (3) for lithium niobate (LN) 67, potassium titanyl phosphate (KTP) 65 potassium dihydrogen phosphate (KDP) 69 and Lithium Iodate (LI) 71. KTP has the highest X⁽²⁾ and Lithium Iodate (LI) 71 has the highest δn_{disp}.

In cases where the poling period is between 5-20 μm and the refractive index step Δn is of the order of 0.01, SHG tunability can range from tens to hundreds of nanometers. Moreover, taking into account the refractive index change due to the dispersion δn_{disp}, SHG tunability of the order of, or even exceeding, the whole visible spectrum is feasible with some crystals having a suitable dispersion curve.

FIG. 4 shows a graph 75 of SHG output power 77 versus launched pump power 79 for several wavelengths related to the main peaks of SHG efficiency as identified in the key 81. Inset 83 is a magnified view of low values of output power and launched power.

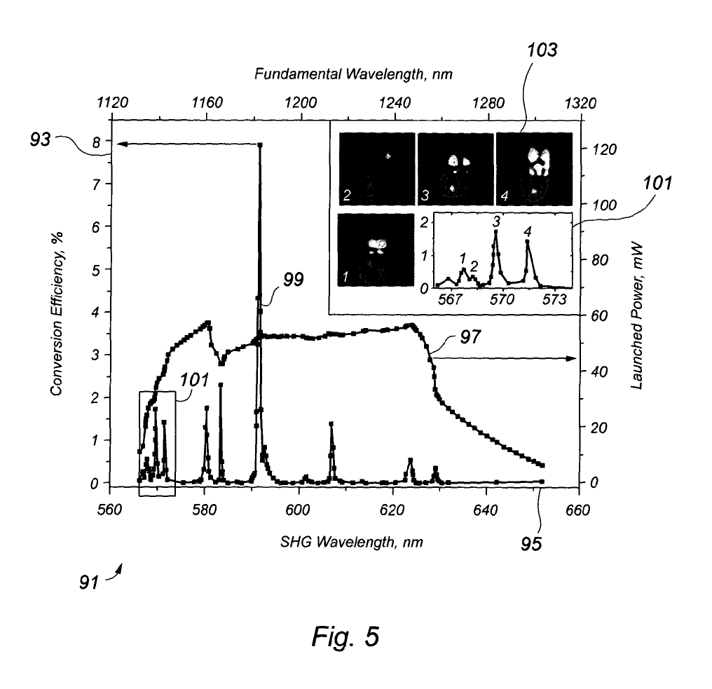

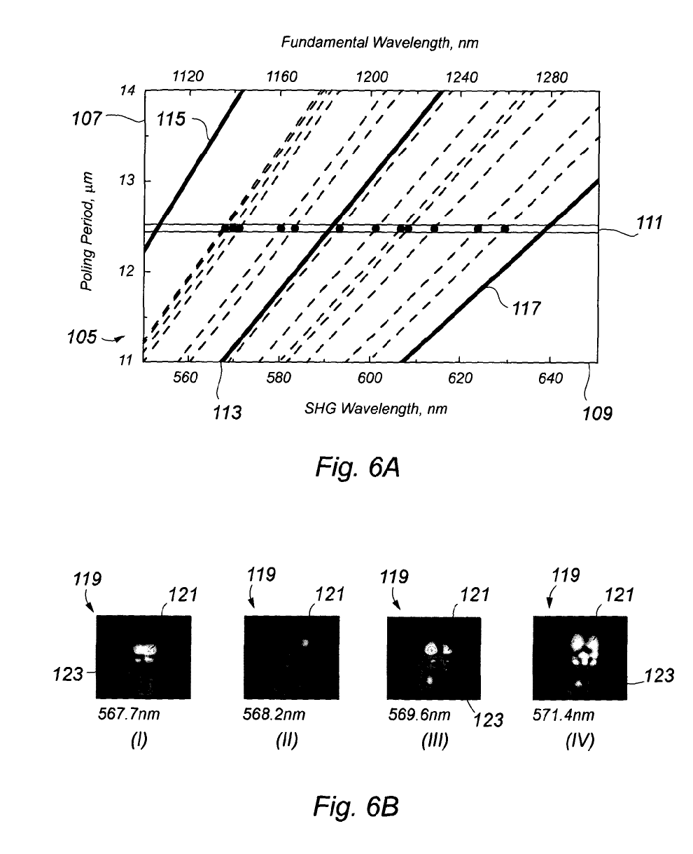

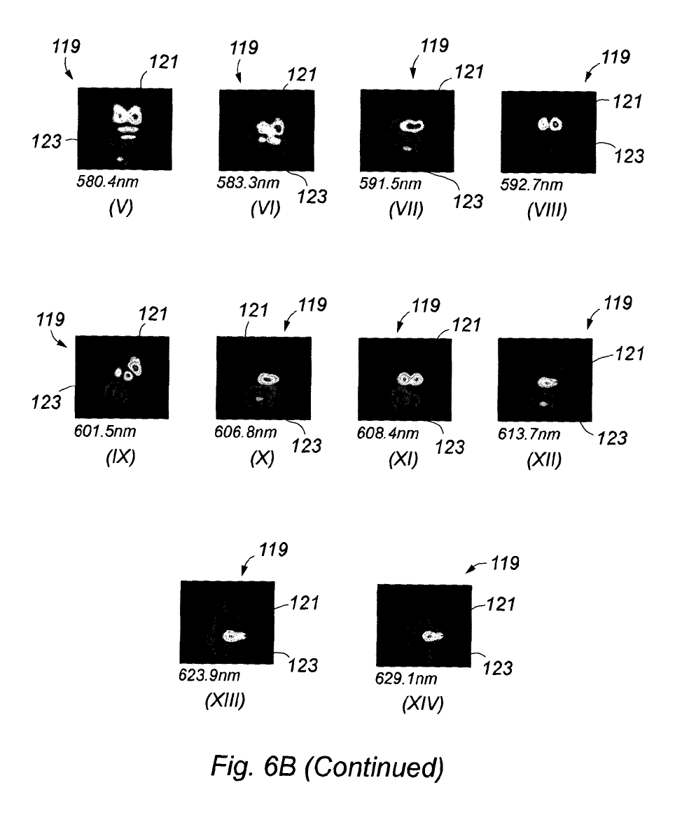

FIG. 5. is a graph 91 of conversion efficiency (%) 93 versus SHG wavelength 95 which shows the dependence on wavelength of SHG conversion efficiency 99 and launched pump power 97. The intensity profiles of second-harmonic and fundamental modes 103 were observed by wavelength tuning of the QD-ECDL. The maximum SHG output power of 4.11 mW at 591.5 nm was achieved for 52 mW of launched pump power at 1183 nm, resulting in a conversion efficiency of 7.9%. All other SHG peaks in the spectral region between 567.7 and 629.1 nm correspond to phase-matching between fundamental and SHG modes of different order. The effect of excitation of different-order modes on SHG wavelength can be seen very clearly in the inset 101 to FIG. 5, where only ˜4 nm tuning involves four different pairs of fundamental and SHG modes. The observed intensity profiles of the fundamental and SHG modes 103 (shown in more detail in FIG. 6b) show that phase-matching between the low-order fundamental and high-order second harmonic modes correspond to the SHG on the blue side of tuning range, and the high-order fundamental and low-order SHG modes are attributed to the frequency doubling on the red side of tuning range.

In the case of high SHG-effective materials with high nonlinearity X⁽²⁾ but inconvenient dispersion (such as LN and KTP), tunability over entire red-green-blue region can be achieved with the introduction of a higher waveguide refractive index step. For LN, Δn up to 0.14 and for KTP, Δn up to 0.04. Selection of the waveguide structure and of the nonlinear material as well as improvement of the laser-to-crystal coupling efficiency can further increase the demonstrated second-harmonic generation tunability and conversion efficiency.

FIG. 6a. is a graph 105 of poling period 107 plotted against SHG wavelength 109. The physical poling period is represented by curve 111. The central dispersion curve, blue SHG margin and red SHG margin are shown at reference numerals 113, 115 and 117 respectively.

FIG. 6b shows black and white illustrations of observed intensity profiles 119 for 13 wavelengths in the spectral region between 567.7 and 629.1 nm marked as I to XIII respectively. In each illustration, the second-harmonic is identified generally by reference numeral 121 and the fundamental modes are identified generally by reference numeral 123. As with FIG. 5, the observed intensity profiles of the fundamental modes 123 and SHG modes 121 show that phase-matching between the low-order fundamental and high-order second harmonic modes correspond to the SHG on the blue side of tuning range, and the high-order fundamental and low-order SHG modes are attributed to the frequency doubling on the red side of tuning range.

FIGS. 6a and 6b illustrate the influence of the waveguide refractive index step on the effective poling period. The physical poling period 111 and the central dispersion curve 113 intersect at the designed wavelength of 1183 nm. The blue SHG margin 115 and the red SHG margin 117 are for the waveguide refractive index step of approx 0.01.

Course wavelength tuning of QD ECDL in CW between 1130 and 1308 nm at 20° C. may be achieved by changing the incidence angle of the grating. The output of the front facet was collimated and coupled into the PPKTP waveguide using an aspheric lens (NA approx 0.55). Both the pump laser and crystal were operating at room temperature.

A second embodiment of the present invention comprises a tunable all-room-temperature picoseconds pulsed laser source in the visible spectral region (between 600 nm and 627 nm) based on a single QD diode laser and a single PPKTP waveguide

In this embodiment of the invention a 13 mm long (not AR coated) PPKTP frequency doubling crystal was periodically poled for SHG at 1226 nm with a poling period of 13.82 microns. The waveguides had a cross sectional area of 4×4 μm² and a reflective index step (Δn) of approximately 0.01.

The gain chip had a total length of 4 mm, and a reverse bias was applied to the section placed near the front facet, thus forming a distributed saturable absorber with a total length of 600 μm while the gain section was forward biased. The ridge waveguide had a width of 6 μm and was angled at 7° relative to the normal of the AR-coated back facet to minimize the reflectivity (both facets had conventional AR coatings, resulting in total estimated reflectivities of 10⁻² for the front facet and less than 10⁻⁵ for the angled facet).

In this example, the pump external-cavity diode laser (ECDL) consisted of a QD gain chip operating under in a quasi-Littrow configuration. Course wavelength tuning of QD EC DL in Mode-Locked regime between 1193 nm and 1284 nm at 20° C. was achieved by changing the incidence angle of the grating. The output of the front facet was collimated and coupled into the PPKTP waveguide using an aspheric lens (NA approx 0.55). Both the pump laser and crystal were operating at room temperature.

A fundamental repetition frequency of ˜0.74 GHz was set-up by adjusting the external-cavity length. Pulsed operation was observed at any wavelength, and the pulse duration varied from 12.8 ps to 39.5 ps. Different mode-locked regimes were investigated. In the fundamental mode-locked operation the maximum output peak power up to 870 mW was achieved at 0.74 GHz. The maximum average output power up to 126 mW was demonstrated in high-order harmonic mode-locked operation at 6.72 GHz. The peak power remains the same for the fundamental and high-order harmonic mode-locked operation in the ECDL configuration. The average output power was found to be approximately proportional to the repetition rate and became higher for high-order mode-locking. This fact was used to achieve high average SHG power.

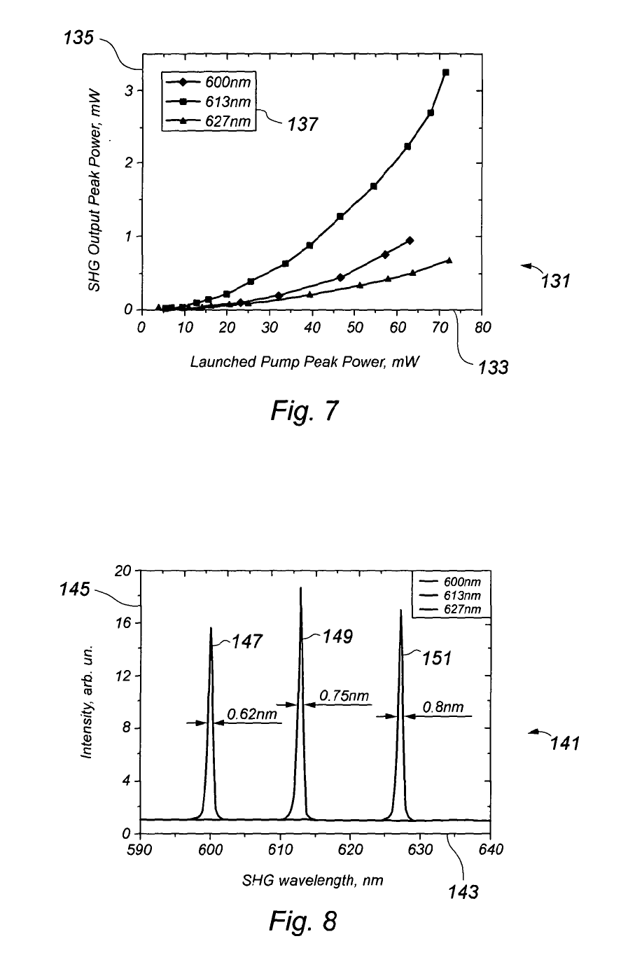

This embodiment of the present invention provides a tunable picosecond SHG in the spectral region between 600 nm and 627 nm in the high-order mode-locked operation with repetition rate between 2.64 GHz and 7.92 GHz and pulse duration between 14.7 ps and 29.3 ps. FIG. 7

FIG. 7 is a graph 131 which plots launched peak power 133 against SHG output for wavelengths of 600 nm, 613 nm and 627 nm as shown in key 137. The maximum SHG output peak power of 3.25 mW corresponding to maximum conversion efficiency of 4.55% at 613 nm was achieved at 6.16 GHz repetition rate and 18.4 ps pulse duration.

FIG. 8 is a graph 141 SHG wavelength 143 plotted against intensity 145 for wavelengths of 600 nm 147, 613 nm 149 and 627 nm 151. The maximum average power of ˜800 μW at 613 nm was also observed. SHG at 600 nm and 627 nm which corresponded to phase-matching between fundamental and SHG modes of different order. This was demonstrated with output peak power of 0.95 mW and 0.66 mW and with conversion efficiency of 1.5% and 0.92%, respectively.

Frequency doubling of infrared light in a non linear crystal containing a waveguide may provide a suitable means for the development of portable laser sources in the orange spectral region where compact and efficient sources are relatively scarce.

Improvements and modifications may be incorporated herein without deviating from the scope of the invention.

1. A frequency doubling tunable laser system, the system comprising a quantum-dot laser optically coupled with a periodically poled nonlinear crystal waveguide.

2. A laser system as claimed in claim 1 wherein the quantum-dot laser is a pump external-cavity diode laser (ECDL) with a Quantum Dot gain chip.

3. A laser system as claimed in claim 1 wherein, the nonlinear crystal waveguide is a single nonlinear crystal waveguide.

4. A system as claimed in claim 1 wherein the quantum dot laser comprises variable size quantum dots.

5. A system as claimed in claim 1 wherein the waveguide structure is adapted for the excitation of higher-order modes to enable the difference between the effective refractive indexes of the fundamental frequency waves and SHG frequency waves to be shifted to match periodic poling.

6. A system as claimed in claim 1 wherein the waveguide is configured to provide a low difference between refractive indexes of low-order fundamental and high-order SHG modes to enable blueshift of the effective poling period whilst a higher difference between high-order fundamental and low-order SHG refractive indices provides a red shift.

7. A system as claimed in claim 1 wherein the, tunability of the system can be extended by increasing the refractive index step of the waveguide Δn

8. A system as claimed in claim 1 wherein, tunability of the system can be extended by choosing material with an appropriate refractive index change due to dispersion.

9. A system as claimed in claim 1 wherein, the waveguide is a periodically poled potassium titanyl phosphate waveguide (KTP).

10. A system as claimed in claim 1 wherein, the waveguide is a periodically poled lithium niobate waveguide.

11. A system as claimed in claim 1 wherein, the waveguide is a periodically poled potassium dihydrogen phosphate (KDP).

12. A system as claimed in claim 1 wherein the periodically poled nonlinear crystal waveguide has a poling period of 5-20 μm.

13. A system as claimed in claim 1 wherein, the laser system provides tunability across a wavelength range of the whole visible spectrum.

14. A system as claimed in claim 1 wherein, the laser system operates at, room temperature.

15. A system as claimed in claim 1 wherein the output beam is reshaped in a multimode fibre.

16. A system as claimed in claim 1 wherein the waveguide utilises aperiodical poling or a tapered waveguide to provide continuous wavelength tuning for realization of the full colour laser source.

17. A system as claimed in claim 1 wherein the laser system is configured to provide a pulsed output.

18. A system as claimed in claim 17 wherein the pulsed output is mode locked.

19. A system as claimed in claim 17 wherein, the pulsed output of the laser system operates in the range 600 nm to 627nm for picoseconds pulse lengths.

20. A system as claimed in claim 1 wherein the system is configured to produce a continuous wave output.

21. A system as claimed in claim 20 wherein the laser emits in a wavelength range of up to 200 nm.
